(19) United States
(12) Patent Application Publication
(10) Pub. No.: US 2013/0083786 A1
(43) Pub. Date: Apr. 4, 2013

(54) METHOD AND APPARATUS FOR SYNCHRONIZATION IN A DYNAMIC SPECTRUM ACCESS (DSA) COGNITIVE RADIO SYSTEM

(71) Applicants: QICAI SHI, CORAL SPRINGS, FL (US); NEIYER S. CORREAL, COOPER CITY, FL (US); SPYROS KYPEROUNTAS, WESTON, FL (US)

(72) Inventors: QICAI SHI, CORAL SPRINGS, FL (US); NEIYER S. CORREAL, COOPER CITY, FL (US); SPYROS KYPEROUNTAS, WESTON, FL (US)

(73) Assignee: MOTOROLA SOLUTIONS, INC., Schaumburg, IL (US)

(21) Appl. No.: 13/248,397

(22) Filed: Sep. 29, 2011

(51) Int. Cl. H04B 15/00; H04W 56/00

(52) U.S. Cl. 370/343; 370/350

(57) ABSTRACT

A method and apparatus for synchronization in a dynamic spectrum access system is provided herein. During operation a transmitter will vary a known sequence to generate a preamble for each radio frame. The variation of the known sequence is based on what particular subcarriers are currently being used by the transmitter. In one embodiment, the preamble is coupled to the filterbank multicarrier synthesis to generate an over-the-air preamble for use in synchronizing a receiver.

### FIELD OF THE INVENTION

The present invention generally relates to synchronization within a communication system, and more particularly to a method and apparatus for synchronization in a dynamic spectrum access cognitive radio system.

### BACKGROUND OF THE INVENTION

In a cognitive radio system, a cognitive secondary radio system will utilize spectrum assigned to a primary system using an opportunistic approach. With this approach, the secondary radio system will share the spectrum with primary incumbents on a secondary basis. Under these conditions, it is imperative that any user in the cognitive radio system not interfere with primary users.

Dynamic Spectrum Access technology allows a radio device to (a) evaluate its radio frequency environment using spectrum sensing, geo-location, or a combination of spectrum sensing and geo-location techniques, (b) determine which frequencies are available for use on a non-interference basis, and (c) reconfigure itself to operate on the identified frequencies. Use of DSA technology will enable radios to opportunistically use idle channels for communications.

An opportunity for public safety is to use DSA techniques to identify vacant channels and create a wide data pipe by aggregating idle narrowband channels. Multicarrier techniques are particularly suitable for operating on non-contiguous blocks of temporarily available channels, dynamically sculpting around channels in use by higher priority licensed users. One of the challenges with multicarrier operation over fragmented spectrum is not causing harmful interference to in-band users. Filter-bank techniques can be used to achieve multicarrier modulation with excellent subcarrier containment. The effective frequency domain subcarrier orthogonality can be leveraged for spectrum sculpting (i.e., bonding idle channels while sculpting around active primary signals).

Correct demodulation of a multicarrier signal requires the multicarrier receiver to be able to establish the arriving time of a packet. Furthermore, the receiver needs to accurately estimate the starting time of the multicarrier symbols for proper demodulation. For these purposes, preamble symbols are inserted in front of the payload of each frame. Conventionally, a fixed preamble is used for each frame for frame synchronization. For an opportunistic dynamic spectrum access system, the conventional preamble approach does not work anymore since it will create spectrum leakage across all the subcarriers and cause harmful interference to primary users of the system.

One solution for this problem is to add tunable notch filters to notch out the appropriate sub-channels right before the RF signal is sent over the air. To avoid the spectrum leaking to the adjacent subcarriers, a sharp notch filter is needed. A sharp notch filter in spectrum domain requires a very high filter-order. A hardware implementation of such frequency tunable notch filter is quite challenging.

Therefore a need exists for a method and apparatus for synchronization in a spectrum sculpting, dynamic spectrum access system that allows for synchronization without causing unnecessary interference.

### BRIEF DESCRIPTION OF THE DRAWINGS

FIG. 1 is a block diagram showing a secondary radio system.

FIG. 2 illustrates the aggregation of narrowband channels.

FIG. 3 illustrates a preamble within a radio frame.

FIG. 4 illustrates a preamble code sequence.

FIG. 5 is the block diagram of circuitry for generating a fine timing template

FIG. 6 is a block diagram of circuitry that generates an adaptive OTA preamble for a DSA cognitive radio system.

FIG. 7 is a block diagram for a transmitter to generate a data frame with an adaptive OTA preamble for a DSA cognitive radio system.

FIG. 8 is a flow chart showing operation of the circuitry described in FIG. 6.

FIG. 9 is a block diagram of a receiver determining a coarse timing window.

FIG. 10 is a block diagram of a receiver having fine timing circuitry.

FIG. 11 is another preferred block diagram of a receiver determining a fine timing signal.

FIG. 12 is a block diagram of a receiver determining a frame starting time based on the coarse timing window and the fine timing signal.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

To address the above-mentioned need, a method and apparatus for synchronization in a dynamic spectrum access system is provided herein. During operation a transmitter will vary a known sequence to generate a preamble for each radio frame. The variation of the known sequence is based on what particular subcarriers are currently being used by the transmitter. In one embodiment, the preamble is coupled to the filterbank multicarrier synthesis to generate an over-the-air preamble for use in synchronizing a receiver. The resulting over-the-air preamble does not cause spectrum leakage into subcarriers whose spectrum is currently occupied by other transmitters. Thus, hardware implementation of frequency tunable notch filter can be eliminated.

The present invention encompasses a method for synchronization in a dynamic spectrum access cognitive radio system. The method comprises the steps of determining spectral conditions, determining a preamble to use based on the spectral conditions, and transmitting the preamble.

The present invention additionally encompasses a method for operating a transmitter as part of a secondary communication system. The method comprises the steps of determining channels currently occupied, determining an I channel preamble code sequence and a Q channel preamble code sequence, and performing filterbank multicarrier synthesis on the I channel preamble code sequence and the Q channel preamble code sequence. Finally, the synthesized I channel preamble and the synthesized Q channel preamble are transmitted.

The present invention additionally encompasses a transmitter comprising spectral awareness circuitry determining spectral conditions, and determining a preamble to use based on the spectral conditions. A transmitter is provided for transmitting the preamble.

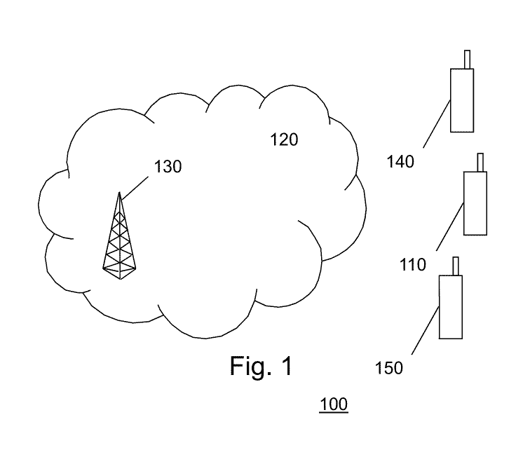

FIG. 1 is a block diagram showing secondary radio system 100 that includes, among other known elements, an infrastructure 120 that contains a base station 130. As shown, several subscribers 110, 140, 150 communicate with other subscribers via the base station 130. Subscribers 110, 140, 150 are part of a secondary radio system utilizing spectrum assigned to a primary system in an opportunistic approach. Examples of secondary systems include Cognitive Radio systems and emergency incident scene response or critical infrastructure (such as smart grid) systems.

In the preferred embodiment of the present invention, system 100 utilizes a filterbank multicarrier system. However, in alternate embodiment's communication system 100 may utilize other wideband communication system architectures.

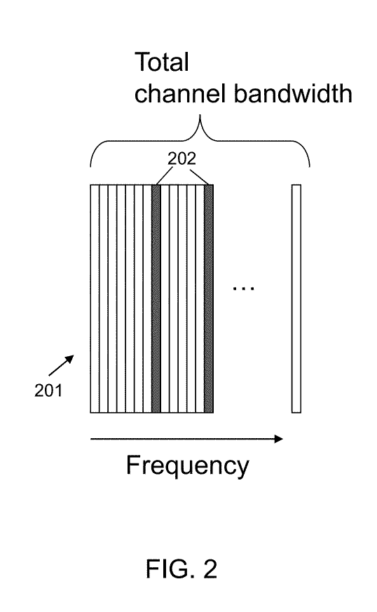

As part of a cognitive radio system, subscribers (radios) 110, 140, and 150 will (a) evaluate its radio frequency environment using spectrum sensing, geo-location, or a combination of spectrum sensing and geo-location techniques, (b) determine which frequencies are available for use on a non-interference basis, and (c) reconfigure itself to operate on the identified frequencies. The vacant channels are used to create a wide data pipe by aggregating idle narrowband channels. This is illustrated in FIG. 2.

As one of ordinary skill in the art will recognize, during operation of a filterbank multicarrier system on an opportunistic basis, a subset of multiple subcarriers (e.g., a subset of 256 subcarriers) is utilized to transmit wideband data. During the transmit process, frequency-domain data symbols are converted into the time domain by synthesis circuitry. Particularly, a signal processing operation such as a Filterbank multicarrier synthesis, Fast Fourier Transform, or other signal processing is performed on a signal to be transmitted to generate a over the air time domain signal. The signal is then transmitted over the air on the particular selected subset of multiple subcarriers.

As shown in FIG. 2 the wideband channel is divided into many narrow frequency bands (subcarriers) 201, with data being transmitted in parallel on a subset of subcarriers 201. In this particular example, subcarriers 202 are occupied by the primary system, and are not utilized by the secondary system. Each frame in a multi-carrier system transmits data on k sub-carriers of a particular channel. The structures of different frames used in various types of communication systems are well known and thus will not be further discussed.

As mentioned above, correct demodulation of a multicarrier signal requires the multicarrier receiver to be able to establish the arriving time of a packet. Furthermore, the receiver needs to accurately estimate the starting time of the multicarrier symbols for proper demodulation. For these purposes, a preamble comprising multiple symbols is inserted in front of the payload of each frame. For an opportunistic dynamic spectrum access system, the conventional wideband preamble approach does not work since it will create spectrum leakage across all the subcarriers and cause harmful interference to primary users of the system.

In order to address this issue, a method and apparatus for synchronization in a dynamic spectrum access system is provided herein. During operation a transmitter will use a known code sequence to generate a preamble for each radio frame. The generated preamble is allowed to vary based on what particular subcarriers are currently being used by other radios (occupied). More particularly, a generated preamble having a length N (where N is the number of sub-channels being used) will have null symbols inserted in corresponding locations associated with occupied subcarriers. So, for example, if subcarrier 24 and 55 are occupied, then the 24^{th} and 55^{th} position of the preamble will be zeroed for the current frame.

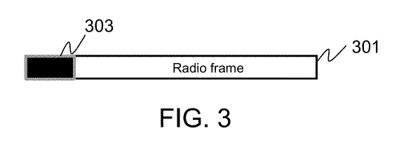

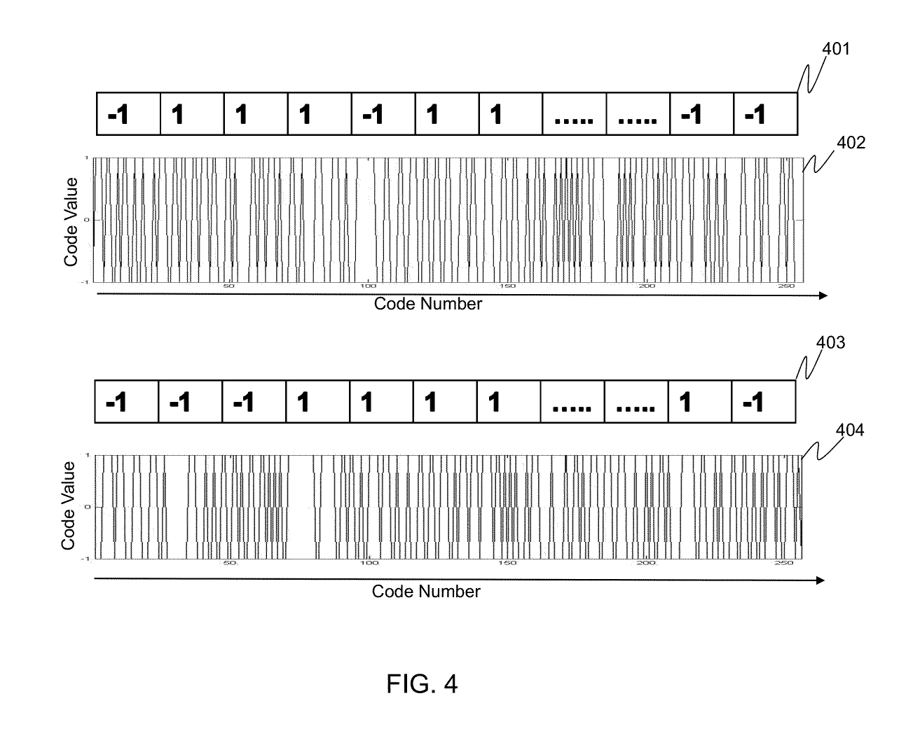

An example is shown in FIG. 3 and FIG. 4. As shown, each radio frame 301 comprises 50 symbols, and begins with preamble 303 of 2 symbols. In order to reduce leakage across all subcarriers, preamble 303 is allowed to dynamically change based on what channels are currently being utilized by other transmitters.

FIG. 4 illustrates a preamble that comprises a code sequence. In order to generate the over-the-air (OTA) preamble, a preamble is first generated as discussed above and then synthesized. The preamble includes two sets 401 and 403 of random sequences of length of N (the number of subcarriers, e.g. 256). Sequence 401 is a sequence for the I-channel. A plot of sequence 401 is shown as plot 402. Sequence 403 is a sequence for the Q-channel. Plot 404 is the plot of sequence 403.

In the preferred embodiment, the values of random sequences 401 and 403 are either “1” or “−1”. In one embodiment, a plurality of (e.g. 1,000,000) sequences are randomly generated. Then three criteria are used for the selection of the best sequence for use by the secondary communication system: a) A strong fine timing correlation peak in time domain; b) A small peak-average power ratio; c) Robust fine timing when some of the subcarriers are “turned-off”. The sequence that is best suited for generating the preamble according to the three criteria is selected as the code sequence. Once the code sequence is generated and selected, it is saved as the known sequence to be used by radios and modified based on spectral conditions. As discussed above, certain values for each I and Q sequence will be forced to zero based on what channels are currently being occupied by another device. Therefore, if another device is operating on sub-channels 24 and 55, then the 24^{th} and 55^{th} position of the I and Q sequences will be set to zero for the current frame. The preamble is allowed to change on a frame-by-frame basis.

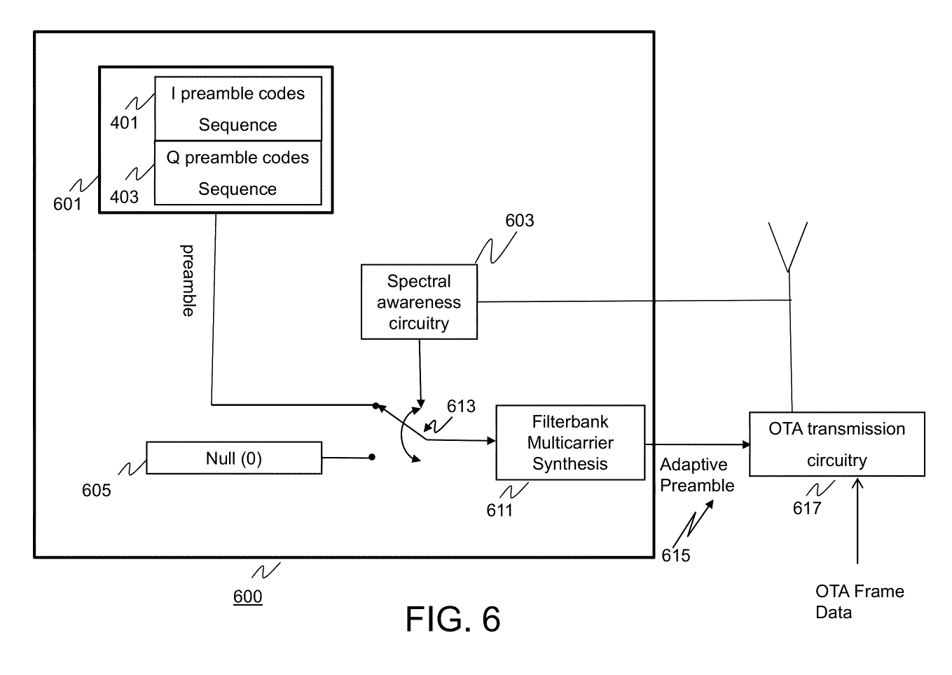

FIG. 6 is a block diagram of circuitry 600 that generates an adaptive over-the-air (OTA) preamble for a DSA cognitive radio system. Components shown within circuitry 600 can be implemented individually, or together on a single digital signal processor (DSP), general purpose microprocessor, programmable logic device, or application specific integrated circuit (ASIC).

Memory 601 stores known sequences generated as described above. As describe, the known sequences are preferably an non-punctured I preamble code sequence 401 and an non-punctured Q preamble code sequence 403. Memory 605 stores null values which comprises a table with N zeros. Switch 613 is provided that operates via spectral awareness circuitry 603. During operation, spectral awareness circuitry 603 analyzes the radio-frequency (RF) environment to determine which subcarriers are occupied by the primary users and which subcarriers are not. In one embodiment, circuitry 603 comprises a wideband receiver that senses what frequencies are currently occupied. If a current subcarrier is occupied by another user, circuitry 603 will control switch 613 to couple into the Null table 605. The resulting preamble will have a zero at the corresponding occupied subcarrier. If current subcarrier being transmitted by transmission circuitry 617 is not occupied, circuitry 603 will control switch 613 to couple into the preamble code sequence stored in memory 601. The output of switch 613 is a preamble that varies on a frame-by-frame basis. The output of switch 613 is coupled to filterbank multicarrier synthesis circuitry 611. Synthesis circuitry 611 then generates the adaptive OTA preamble 615. Filterbank multicarrier synthesis 611 is a well-known technology as is described by Multirate Signal Processing for Communication Systems, Fredric J Harris, published by Prentice Hall PTR, May 2004.

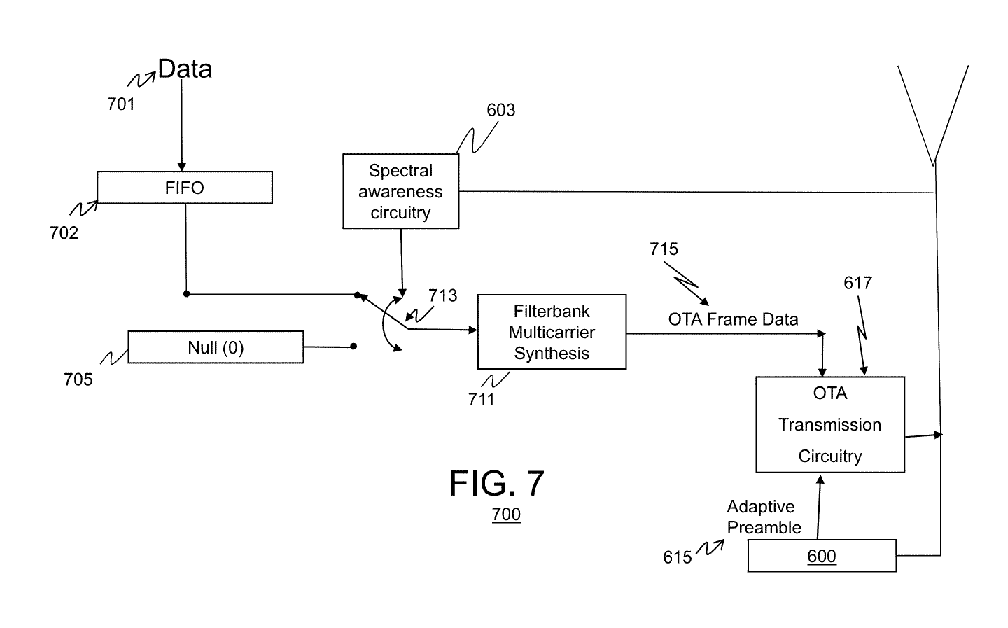

FIG. 7 is a block diagram of a transmitter 700 generating a full data frame with an adaptive OTA preamble for a DSA cognitive radio system. Components shown within transmitter 700 can be implemented individually, or together on a single digital signal processor (DSP), general purpose microprocessor, programmable logic device, or application specific integrated circuit (ASIC).

Transmitter 700 incorporates circuitry 600. As shown, resource data 701 is coupled to a FIFO (first-in-first-out) buffer/memory 702. FIFO 702 is used to avoid data bit loss when a null symbol is transmitted. FIFO 702 is coupled to switch 713. Memory 705 comprises null values (zeros). During operation, spectral awareness circuitry 603 analyzes the radio-frequency (RF) environment to determine which subcarriers are occupied and which subcarriers are not. If a current subcarrier is occupied by a primary user, circuitry 603 will control switch 713 to couple to null table 705. If current subcarrier is not occupied by a primary user, circuitry 603 will control switch 713 to couple to data 701. The output of switch 713 is coupled to filterbank multicarrier synthesis circuitry 711. Circuitry 711 then generates the OTA frame data 715. OTA transmission circuitry 617 combines data 715 with preamble 615 by inserting preamble 615 at the beginning of data 715. Then the completed frame is then transmitted.

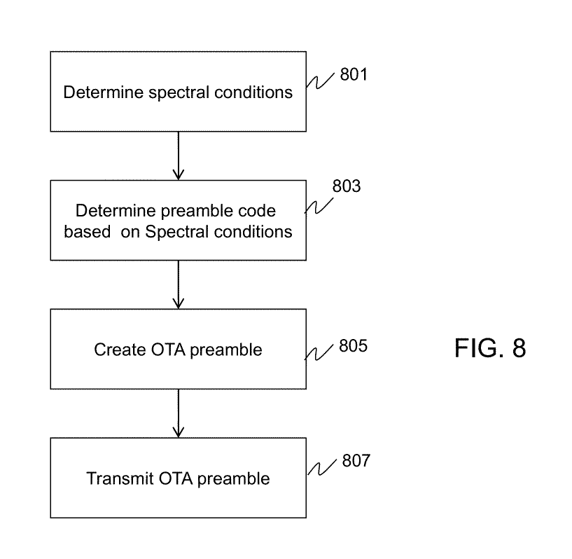

FIG. 8 is a flow chart showing operation of the transmitter shown in FIG. 6. In particular, the steps shown in FIG. 8 show those steps utilized by a transmitter to aide in synchronization. The logic flow begins at step 801 where spectral awareness circuitry 603 determines spectral conditions. More particularly, circuitry 603 comprises a wideband receiver that senses what frequencies are currently occupied. The occupied channels may be the result of a primary communication system using them for transmissions. At step 803 a preamble for use is determined by spectral awareness circuitry 603 based on the spectral conditions, where the preamble is utilized by a receiver for synchronization. As discussed above, the preamble is determined by circuitry 603 sensing occupied subcarriers (e.g., occupied by a primary user of the system) and forcing positions within a stored preamble code sequence to zero at the determined positions. In a particular embodiment, the preamble comprises both an I channel preamble and a Q channel preamble.

At step 805 synthesis circuitry 611 then creates an OTA preamble from the preamble output by switch 613. This is accomplished by performing filterbank multicarrier synthesis on the preamble to produce a synthesized preamble (OTA preamble). Finally, transmission circuitry 617 transmits the OTA preamble (step 807). As discussed, transmission takes place on multiple subcarriers that may be contiguous or non-contiguous.

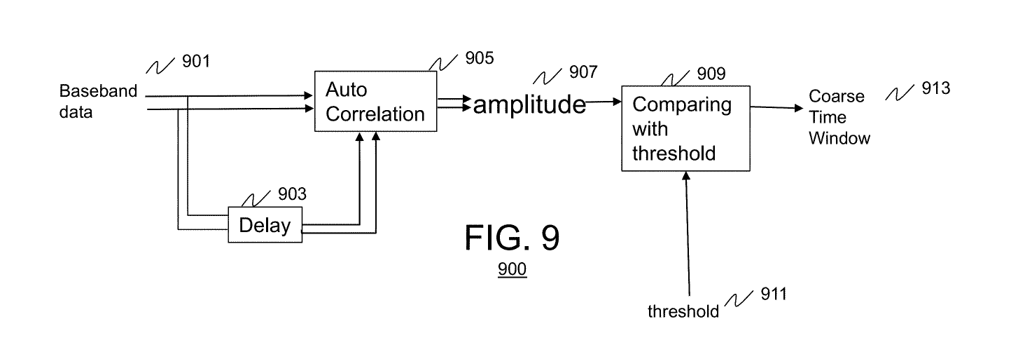

Frame synchronization for a receiver utilizes both coarse timing and fine timing. FIG. 9 is the block diagram of receiver 900 performing coarse timing. The received preamble signal is converted to baseband data 901. Baseband data 901 is delayed by a delay circuitry 903. A preferred delay time is one symbol period. The delayed version of data 901 is then auto-correlated with data 901 by correlator 905. The amplitude for a sliding correlation is then calculated with circuitry 905. Amplitude versus time is then output by correlator 905. Comparison circuitry 909 compares the amplitude with a threshold 911. A preferred threshold is the normalized power of baseband signal 901. A coarse time window 913 is then output by comparison circuitry 909. In the preferred embodiment of the present invention, the coarse time window is time that the correlation output signal is stronger than the threshold.

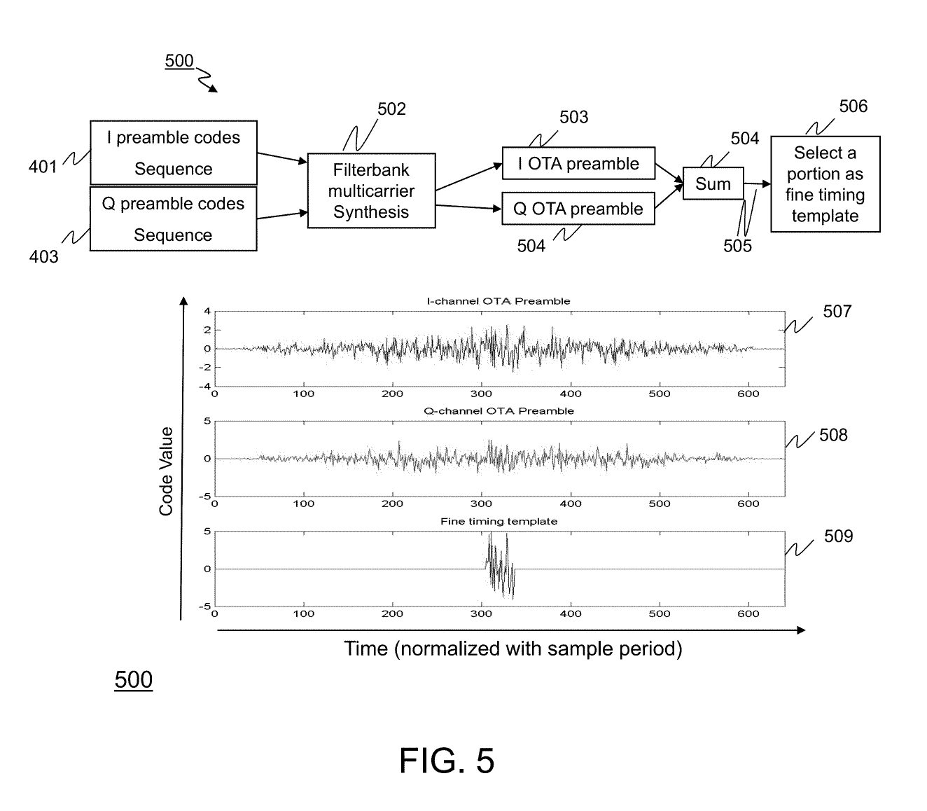

FIG. 5 is the block diagram of circuitry 500 for generating a fine timing template that is needed by the receivers for fine timing. Both I preamble code sequence (401) and Q preamble code sequence (403) are coupled into a filterbank multicarrier synthesis circuitry (502) to generate the over-the-air preamble. As discussed above, synthesis circuitry 502 performs a domain transformation on the I and Q sequence, shifting the frequency domain I and Q code sequences to the time domain. In order to generate the fine timing template, all the codes of both the I and the Q code sequences are used.

For fine timing template generation, the output of circuitry 502 is the full (i.e., no puncturing of I code sequence and Q code sequence) over-the-air preambles in the time domain. Preamble 503 is the I-channel over-the-air preamble and preamble 504 is the Q-channel over-the-air preamble. Summer 504 sums the I preamble and the Q preamble to result in template 505. Portion 506 of template 505 is generated to serve as fine timing template 506. The size of template 506 is dependent upon the hardware resource and dependent on the total bandwidth of the system. In one embodiment, as shown in FIG. 5, the size of template 506 is 1/10th of the size of sequence 505 in the time domain. Graph 507 illustrates the I OTA preamble 503 in the time domain. Graph 508 illustrates the Q OTA preamble 504 in the time domain. Finally, graph 509 illustrates the fine timing template 506 in the time domain.

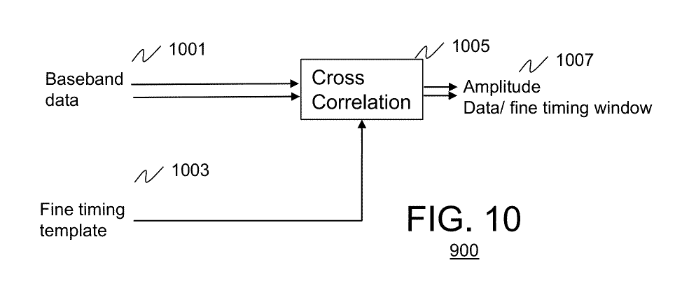

FIG. 10 is the block diagram of fine timing circuitry existing within receiver 900. The received preamble signal is converted to baseband signal 1001, baseband signal 1001 is input into cross correlation circuitry 1005. A fine timing template 1003 (pre calculated and saved in memory) is also input to cross correlation circuitry 1005. Baseband data 1001 (containing a preamble) and fine timing template 1003 are cross correlated by correlation circuitry 1005. Correlation circuitry 1005 outputs amplitude data for a sliding correlation of template 1003 to baseband data 1001. Amplitude 1007 is used by the receiver to determine the frame time.

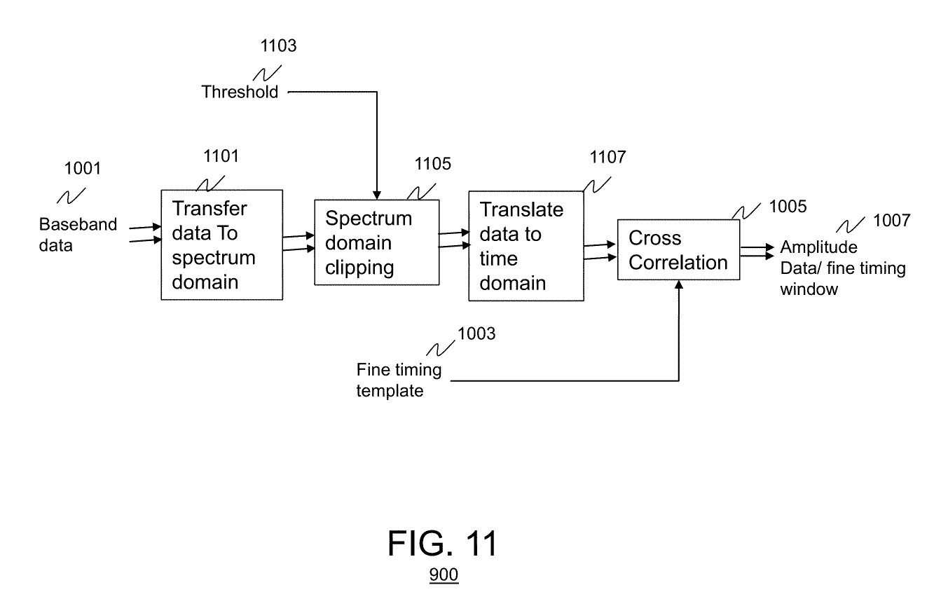

FIG. 11 is a block diagram of a receiver having fine timing circuitry. For this particular embodiment the received preamble signal is converted to baseband signal 1001. Signal 1001 is input to the signal transform circuitry 1101. Circuitry 1101 transfers the baseband signal into the spectrum domain. A preferred transform circuitry comprises an FFT modem. The spectrum domain signal from 1101 is coupled to a signal clipping circuitry 1105. Threshold 1103 is also coupled to clipping circuitry 1105. Clipping circuitry 1105 compares the signal amplitude with the threshold 1103. If the signal amplitude is greater than the threshold 1103, then signal is clipped by clipping circuitry 1105. One embodiment of clipping function comprises trimming the signal points that are greater than the threshold. Another embodiment of clipping function comprises zeroing out the signal points that are greater than the threshold. A preferred threshold is a percentage (e.g. 20%) above the average signal amplitude.

The clipped signal is coupled to another signal transform circuitry 1107. Transform circuitry 1107 transfers the clipped signal back to the time domain. In one embodiment circuitry 1107 comprises an IFFT modem. Then the signal from IFFT modem 1107 is input into cross correlation circuitry 1005. A fine timing template 1003 (pre calculated and saved in memory) is also input to cross correlation circuitry 1005. The output of transform circuitry 1107 and fine timing template 1003 are cross correlated by correlation circuitry 1005. Correlation circuitry 1005 outputs amplitude data for a sliding correlation of template 1003 to baseband data 1001. Amplitude 1007 is used by the receiver to determine the frame time.

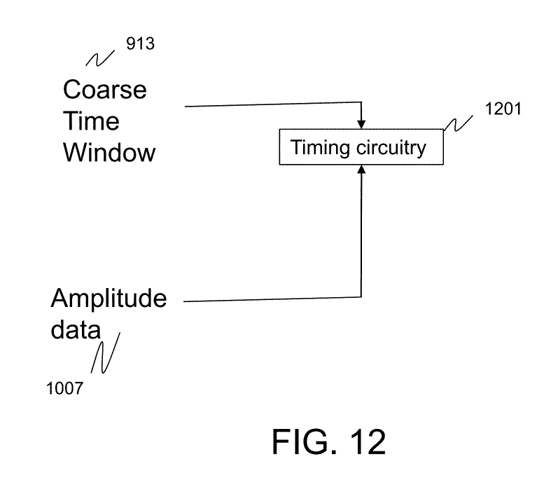

FIG. 12 is a block diagram of circuitry existing within receiver 900 to perform frame timing. The coarse time window 913 and the amplitude data 1007 are coupled to timing circuitry 1201. Timing circuitry 1201 determines the fine timing peak within the coarse timing window.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for synchronization in a dynamic spectrum access cognitive radio system, the method comprising the steps of:
at a transmitter:
determining spectral conditions;
determining a preamble to use based on the spectral conditions, wherein the determined preamble is utilized by a receiver for synchronization; and
transmitting the preamble.

2. The method of claim 1 wherein the spectral conditions comprise what channels are being used for transmission.

3. The method of claim 1 wherein the step of determining the preamble to use comprises the step of forcing positions within a stored preamble code sequence to zero at the determined positions.

4. The method of claim 3 further comprising the step of performing filterbank multicarrier synthesis on the determined preamble to produce a synthesized preamble.

5. The method of claim 4 wherein the step of transmitting the preamble comprises the step of transmitting the synthesized preamble.

6. The method of claim 5 wherein the step of transmitting further comprises the step of transmitting on multiple sub-carriers.

7. A method for operating a transmitter as part of a secondary communication system, the method comprising the steps of:
determining channels currently occupied;
determining an I channel preamble and a Q channel preamble, wherein the I channel preamble and the Q channel preamble vary based on what channels are currently occupied;
performing filterbank multicarrier synthesis on the I channel preamble and the Q channel preamble; and
transmitting the synthesized I channel preamble and the synthesized Q channel preamble.

8. The method of claim 7 wherein the step of determining the I channel preamble and the Q channel preamble comprises the step of determining positions within an I channel preamble sequence and positions within a Q channel preamble sequence stored that will be set to zero at the determined positions.

9. The method of claim 7 wherein the step of transmitting further comprises the step of transmitting on multiple sub-carriers.

10. A transmitter comprising:
spectral awareness circuitry determining spectral conditions, and determining a preamble to use based on the spectral conditions, wherein the determined preamble is utilized by a receiver for synchronization; and
a transmitter transmitting the preamble.

11. The apparatus of claim 10 wherein the spectral conditions comprise what channels are being used for transmission.

12. The apparatus of claim 10 wherein the spectral awareness circuitry determines the preamble to use by determining positions within a stored preamble code sequence that will be set to zero at the determined positions.

13. The apparatus of claim 12 further comprising
filterbank multicarrier synthesis circuitry performing multicarrier synthesis on the determined preamble to produce a synthesized preamble.

14. The apparatus of claim 13 wherein the transmitter transmits the synthesized preamble.

15. The apparatus of claim 14 wherein the transmitter transmits on multiple sub-carriers.
